(19) United States
(12) Patent Application Publication
(10) Pub. No.: US 2013/0162048 A1
(43) Pub. Date: Jun. 27, 2013

(54) POWER MODULE AND MULTI POWER SUPPLY APPARATUS HAVING THE SAME

(71) Applicant: Samsung Electro-Mechanics Co., Ltd., Gyunggi-do (KR)

(72) Inventors: Chong Eun KIM, Gyunggi-do (KR); Jin Wook KIM, Gyunggi-do (KR); Hyung Suk KIM, Gyunggi-do (KR); Jae Bum LEE, Gyunggi-do (KR); Sang Hyun Park, Gyunggi-do (KR); Je Hyung CHO, Gyunggi-do (KR); Hyun Wook SUNG, Gyunggi-do (KR); Don Sik KIM, Gyunggi-do (KR); Jin Sik PARK, Gyunggi-do (KR)

(73) Assignee: SAMSUNG ELECTRO-MECHANICS CO., LTD., Gyunggi-do (KR)

(21) Appl. No.: 13/683,461

(22) Filed: Nov. 21, 2012

(30) Foreign Application Priority Data
Dec. 22, 2011 (KR) 10-2011-0140039

(51) Int. Cl. H02M 1/36; H02J 1/10; H02M 3/335

(52) U.S. Cl. CPC H02M 1/36; H02M 3/335; H02J 1/102
USPC 307/82; 363/17

(57) ABSTRACT

There are provided a power module and a multi power supply apparatus having the same. The multi power supply apparatus includes a plurality of power modules connected in parallel with each other and supplying a preset power, each power module including: a DC/DC converting unit converting an input power into a preset DC power; an output controlling unit switched on or switched off according to a difference between a voltage level of the DC power of the DC/DC converting unit and a voltage level applied to a load end to control an output of the DC power; and a controlling unit starting a soft start operation of the DC/DC converting unit during a hot swap in which the power module is replaced and stopping the soft start operation of the DC/DC converting unit when the output controlling unit is switched on.

### CROSS-REFERENCE TO RELATED APPLICATIONS

This application claims the priority of Korean Patent Application No. 10-2011-0140039 filed on Dec. 22, 2011, in the Korean Intellectual Property Office, the disclosure of which is incorporated herein by reference.

### BACKGROUND OF THE INVENTION

1. Field of the Invention

The present invention relates to a power module capable of suppressing a phenomenon in which an inrush current is generated during a hot swap, and a multi power supply apparatus having the same.

2. Description of the Related Art

Generally, various electronic apparatuses satisfying various needs of users have been variously implemented. These electronic apparatuses may use a power supply apparatus to supply operating power in order to implement various functions therein.

The power supply apparatus may generally adopt a switching mode power supply scheme due to advantages such as power conversion efficiency, miniaturization, and the like.

As this power supply apparatus, there may be a multi power supply apparatus having a plurality of power modules in order to supply large-capacity power to an electronic apparatus requiring the large-capacity power such as a server.

FIG. 1 is a schematic diagram illustrating the configuration of a general multi power supply apparatus.

Referring to FIG. 1, the general multi power supply apparatus may include first to N-th power modules connected to each other in parallel, and the first power module may include an electromagnetic interference (EMI) filtering unit, a rectifying unit, a power factor compensating unit, a DC/DC converting unit, and an output switch.

Since a failure may be generated in this multi power supply apparatus, the power module may be individually replaced. In this case, a hot swap method of removing only the failed power module and inserting a new power module without entirely cutting power may be used, due to ease in performing maintenance, repairs, and upgrades.

However, in a case in which a single power module is hot-swapped while the multi power supply apparatus is operating, an excessive inrush current may be generated in the newly inserted power module, as shown in FIG. 2.

Referring to FIG. 2, current distribution of the plurality of power modules connected in parallel with each other may be controlled. It may be confirmed that in the case in which a voltage level of a load end is lower than that of a power module newly inserted in a hot swap in a normal operational situation, an inrush current is generated in an output current I_{O}_{_{—}}_{NEW} of the newly inserted power module as compared to output currents I_{O}1 and I_{O}2 of a power module that is being operated in advance.

The reason why the inrush current is generated during a hot swap as described above is that output voltages of the plurality of power modules connected in parallel with each other do not coincide with each other. An excessive inrush current may cause hot swap failure or damage to an element of the power module due to an overcurrent.

### SUMMARY OF THE INVENTION

An aspect of the present invention provides a power module capable of suppressing a phenomenon that an inrush current is generated by stopping soft switching and fixing a voltage command value when a voltage level of output power of a power module is higher than that of power applied to a load during a hot swap of the power module, and a multi power supply apparatus having the same.

According to an aspect of the present invention, there is provided a power module including: a DC/DC converting unit converting an input power into a preset DC power; an output controlling unit switched on or switched off according to a difference between a voltage level of the DC power of the DC/DC converting unit and a voltage level applied to a load end to control an output of the DC power; and a controlling unit starting a soft start operation of the DC/DC converting unit during a hot swap and stopping the soft start operation of the DC/DC converting unit when the output controlling unit is switched on.

According to another aspect of the present invention, there is provided a multi power supply apparatus including: a plurality of power modules connected in parallel with each other and supplying a preset power, each of the plurality of power modules including: a DC/DC converting unit converting an input power into a preset DC power; an output controlling unit switched on or switched off according to a difference between a voltage level of the DC power of the DC/DC converting unit and a voltage level applied to a load end to control an output of the DC power; and a controlling unit starting a soft start operation of the DC/DC converting unit during a hot swap in which the power module is replaced and stopping the soft start operation of the DC/DC converting unit when the output controlling unit is switched on.

The controlling unit may increase a voltage command value of the DC/DC converting unit while controlling the soft start operation and fix a corresponding voltage command value as a final voltage command value while controlling the stopping of the soft start operation.

The controlling unit may include an analog to digital converter converting a voltage level of the DC power, a current level of output power of the output controlling unit, and a current level of power transferred to a power coupling line in which the output power is coupled to another output power into respective digital signals; a switching controller controlling the soft start operation of the DC/DC converting unit based on the digital signals converted by the analog to digital converter; and an inrush current prevention controller controlling the switching controller to stop the soft start operation of the DC/DC converting unit when the output controlling unit is switched on or the voltage level of the DC power is higher than the voltage level applied to the load end.

The output controlling unit may include an output switch switched on or switched off according to a switching control signal to output the DC power of the DC/DC converting unit; and an output switching controller providing the switching control signal allowing the output switch to be switched on or switched off.

The power module may further include an electro-magnetic interference (EMI) filtering unit filtering EMI from AC power; a rectifying unit rectifying the filtered AC power; and a power factor compensating unit adjusting a phase difference between a voltage and a current of the rectified power to compensate for a power factor.

The DC/DC converting unit may include a switching unit switching the input power; a transforming unit including a transformer having a primary winding receiving the switched power and a secondary winding forming a preset turns ratio with regard to the primary winding to transform a voltage level; and a rectifying/stabilizing unit rectifying and stabilizing power from the transforming unit.

The switching unit may have a half-bridge, a full-bridge, or a push-full type switch structure.

The rectifying/stabilizing unit may include first and second synchronous rectifying elements respectively connected to both ends of the secondary winding of the transformer to rectify output power; and an inductor and a capacitor connected to a center tap of the secondary winding to stabilize the output power.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram illustrating the configuration of a general multi power supply apparatus;

FIG. 2 is a graph of inrush current generated during a hot swap;

FIG. 3 is a schematic diagram illustrating the configuration of a multi power supply apparatus according to an embodiment of the present invention;

FIG. 4 is a diagram illustrating the detailed configuration of a power module used in a multi power supply apparatus according to an embodiment of the present invention;

FIG. 5 is an operational flowchart for suppressing inrush current of a power module used in a multi power supply apparatus according to an embodiment of the present invention;

FIGS. 6A and 6B are, respectively, current graphs showing a case in which a load end voltage of a power module is higher than an output voltage and a case in which the load end voltage of the power module is lower than the output voltage; and

FIG. 7 is a current graph of a power module used in a multi power supply apparatus according to an embodiment of the present invention.

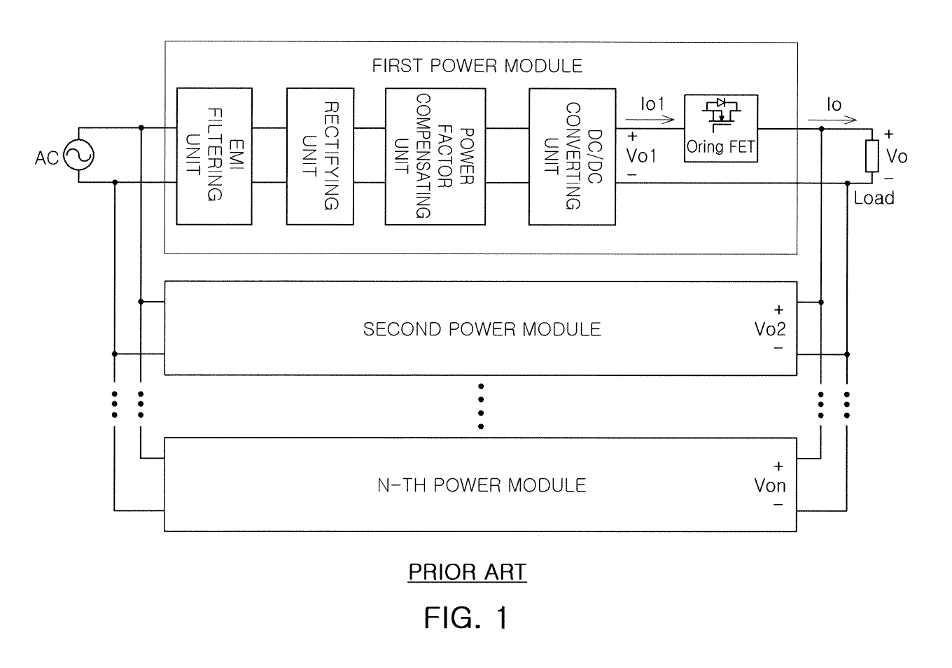

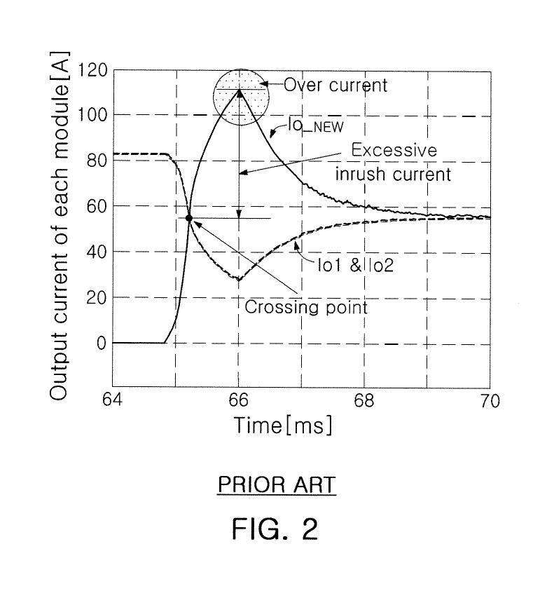

### DETAILED DESCRIPTION OF THE EMBODIMENTS

Hereinafter, embodiments will be described in detail with reference to the accompanying drawings so that they can be easily practiced by those skilled in the art to which the present invention pertains.

However, detailed descriptions related to well-known functions or configurations will be ruled out in order not to unnecessarily obscure subject matters of the present invention.

In addition, like reference numerals will be used to describe elements having the same or similar functions throughout the accompanying drawings.

Throughout this specification, it will be understood that when an element is referred to as being “connected to another element, it can be directly connected to the other element or may be indirectly connected to the other element with element(s) interposed therebetween.

In addition, unless explicitly described to the contrary, the word “comprise” and variations such as “comprises” or “comprising,” will be understood to imply the inclusion of stated elements but not the exclusion of any other elements.

Embodiments of the present invention will now be described in detail with reference to the accompanying drawings.

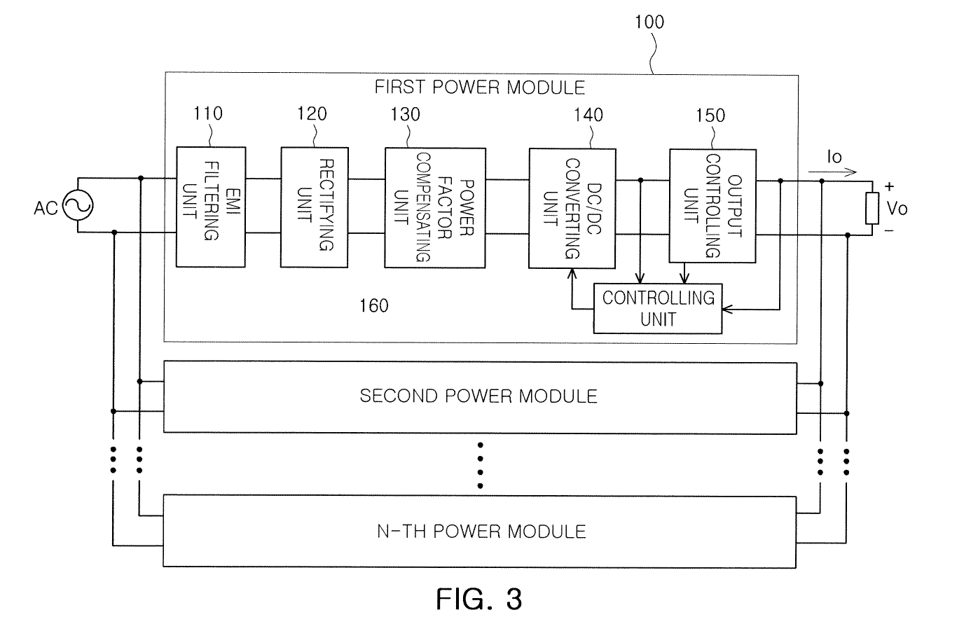

FIG. 3 is a schematic diagram illustrating the configuration of a multi power supply apparatus according to an embodiment of the present invention.

Referring to FIG. 3, the multi power supply apparatus according to the embodiment of the present invention may include first to N-th power modules.

Output powers of the first and N-th power modules may be combined to be output as a single power, and the first and N-th power modules may perform a hot swap function in which the power modules maybe replaced in a state in which power is applied to the multi power supply apparatus.

A first power module 100 among the first and N-th power modules will be described by way of example.

The power module 100 may include an electro-magnetic interference (EMI) filtering unit 110, a rectifying unit 120, a power factor compensating unit 130, a DC/DC converting unit 140, an output controlling unit 150, and a controlling unit 160.

The EMI filtering unit 110 may filter electromagnetic interference (EMI) from AC power.

The rectifying unit 120 may rectify the AC power filtered by the EMI filtering unit 110.

The power factor compensating unit 130 may adjust a phase difference between voltage and current of the power rectified from the rectifying unit 120 to compensate for a power factor.

The DC/DC converting unit 140 may switch input power from the power factor compensating unit 130 to convert the input power into a preset DC power.

The output controlling unit 150 may be switched on or switched off according to a difference between a voltage level of the DC power from the DC/DC converting unit 140 and a voltage level applied to a load end to thereby control an output of the DC power.

The controlling unit 160 may control a power conversion operation of the DC/DC converting unit 140. Particularly, the controlling unit 160 may start a soft start operation of the DC/DC converting unit 140 during a hot swap and stop the soft start operation of the DC/DC converting unit 140 when the output controlling unit 150 is switched on.

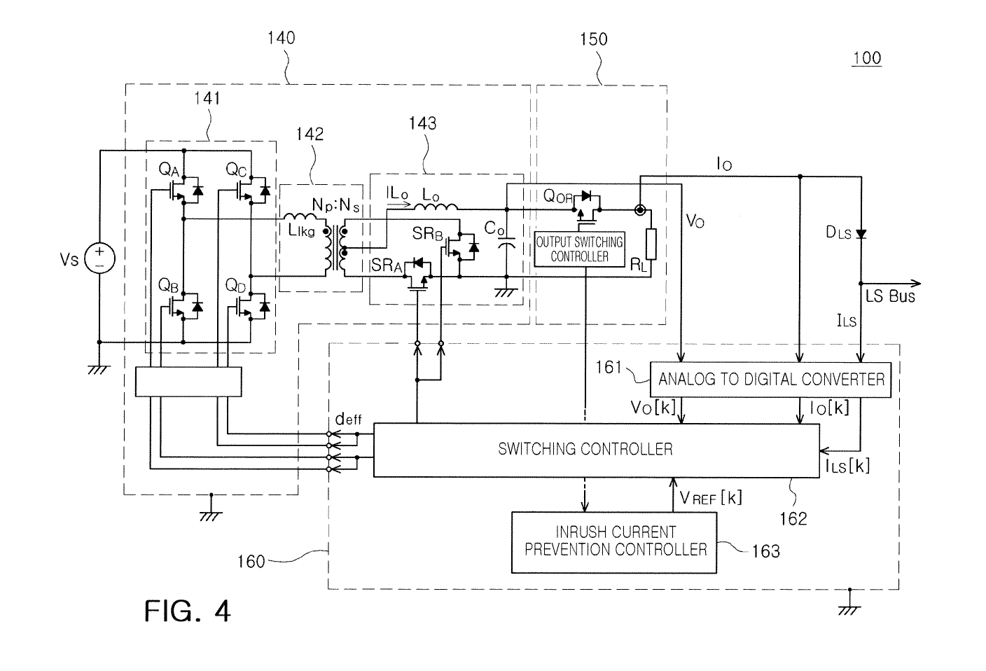

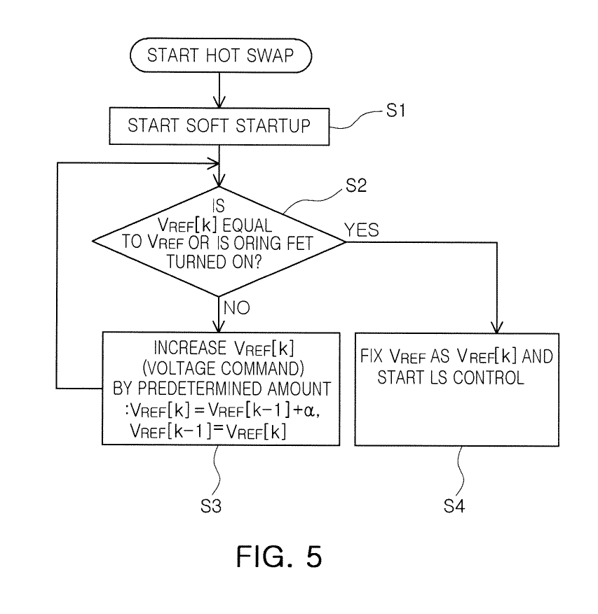

FIG. 4 is a diagram illustrating the detailed configuration of a power module used in the multi power supply apparatus according to an embodiment of the present invention; and FIG. 5 is an operational flow chart for suppressing inrush current of a power module used in a multi power supply apparatus according to an embodiment of the present invention.

Referring to FIG. 4, the DC/DC converting unit 140 of the power module 100 used in the multi power supply apparatus according to the embodiment of the present invention may include a switching unit 141, a transforming unit 142, and a rectifying/stabilizing unit 143.

The switching unit 141 may include a plurality of switches to switch input power V_{S} and may have, for example, a full-bridge type switch structure in which it includes first and second switches Q_{A} and Q_{B} connected in series with each other between both ends of an input power terminal to which the input power Vs is applied and third and fourth switches Q_{c} and Q_{D} connected in series with each other between both ends of the input power terminal and connected in parallel with the first and second switches Q_{A} and Q_{B} as shown in FIG. 4. Although not shown, the switching unit 141 may have various structures such as a half-bridge type switch structure, a push-pull type switch structure, or the like.

The transforming unit 142 may include a transformer. The transformer may have a primary winding Np having both ends respectively connected to a connection point between the first and second switches Q_{A} and Q_{B} and a connection point between the third and fourth switches Q_{c} and Q_{D} and receiving the power switched from the switching unit 141, and a secondary winding N_{S} forming a preset turns ratio with regard to the primary winding N_{P} to transform a voltage level of the switched power. In addition, the transformer may include a leakage inductance component L_{lkg}, and the secondary winding N_{S} may have a center tap.

The rectifying/stabilizing unit 143 may include first and second synchronous rectifying elements SR_{A} and SR_{B} respectively connected to both ends of the secondary winding N_{S} and an inductor L_{O} and a capacitor C_{O} connected to the center tap of the secondary winding N_{S}.

The first and second synchronous rectifying elements SR_{A} and SR_{B} may be synchronized with switching of the switching unit 141 and may be alternately switched to rectify power output from the secondary winding N_{S}.

The inductor L_{O} and the capacitor C_{O} may stabilize the power rectified by the first and second rectifying elements SRA and SRB to output the DC power.

The output controlling unit 150 may include an output switch Q_{OR} and an output switching controller C_{ON}.

The output switch Q_{OR} may be switched on or switched off according to a switching control signal to perform a control to output or block the DC power from the DC/DC converting unit 140.

The output switching controller C_{ON} may provide a switching control signal controlling the switching on or the switching off of the output switch Q_{OR} and control the output switch Q_{OR} so as to be switched on when a voltage level of the DC power of the DC/DC converting unit 140 is higher than that of a load end.

The controlling unit 160 may include an analog to digital converter 161, a switching controller 162, and an inrush current prevention controller 163.

The analog to digital converter 161 may convert a voltage level Vo of the DC power of the DC/DC converting unit 140, a current level I_{O} of the output power of the output controlling unit 150, and a current level I_{LS} of power transferred to a power coupling line in which the output power is coupled to another output power into digital signals.

Detected voltage V_{O}[k] of the DC power, detected current I_{O}[k] of the output power, and detected current I_{LS}[k] of the power coupling line may be transferred to the switching controller 162.

The switching controller 162 may control the switching of the switching unit 141 and the switching of the first and second synchronous rectifying elements SR_{A} and SR_{B} based on the detected voltage V_{O}[k] of the DC power, the detected current I_{O}[k] of the output power, and the detected current I_{LS}[k] of the power coupling line.

In addition, the switching controller 162 may control a soft start operation of the switching unit 141 based on the detected voltage V_{O}[k] of the DC power, the detected current I_{O}[k] of the output power, and the detected current I_{LS}[k] of the power coupling line (S1). That is, the switching controller 162 may control a switching degree of the switching unit 141 according to a voltage command value V_{REF}[k] during the hot swap at which the power module is replaced, thereby allowing a voltage level of the DC power of the DC/DC converting unit 140 to be in accordance with the voltage command value, and stepwise increase the voltage command value to control the voltage level of the DC power so as to slowly rise (S3).

In the case in which the voltage level of the DC power of the DC/DC converting unit 140 is higher than that of the load end or the output switching controller C_{ON} provides the switching control signal allowing the output switch Q_{OR} to be switched on (S2), the inrush current prevention controller 163 may fix a voltage command value in that case as a final voltage command value and then transfer the fixed voltage command value to the switching controller 162, and the switching controller 162 may stop the soft start operation of the switching unit 141 accordingly (S4).

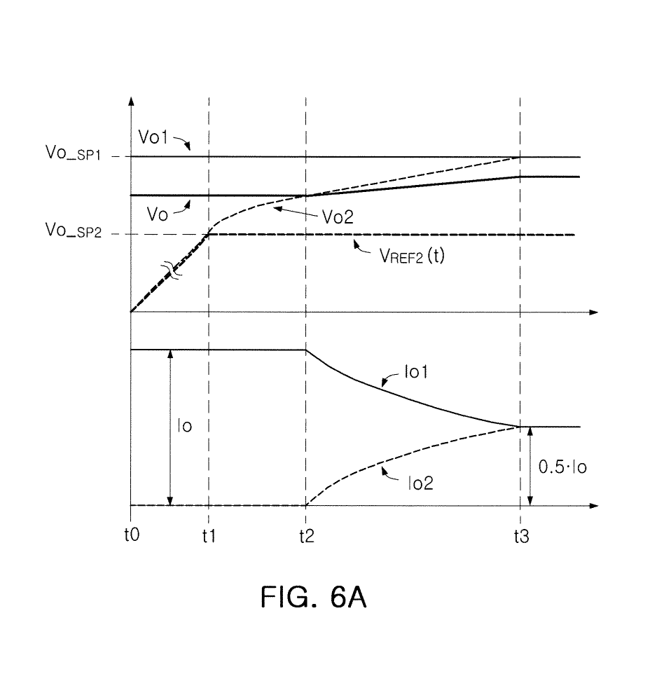

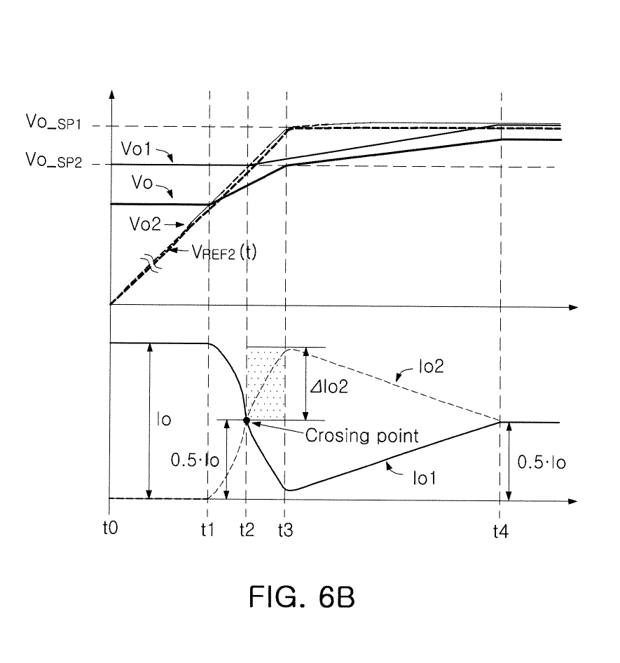

FIGS. 6A and 6B are, respectively, current graphs showing a case in which a load end voltage of a power module is higher than an output voltage and a case in which the load end voltage of the power module is lower than the output voltage.

Referring to FIG. 6A, in the case in which a load end voltage of a power module is higher than an output voltage, an inrush current may not be generated. More specifically, when it is assumed that a second power module is inserted in a situation in which a first power module is normally operated, an output voltage V_{O}1 of the first power module may be changed according to a load end voltage V_{O} and voltage drop by the output switch Q_{OR}. Here, in the case in which a voltage command value V_{REF}2 of the inserted second power module is higher than the load end voltage V_{O}, a soft start operation of the second power module ends before a time t2, and an output voltage V_{O}2 of the second power module rises by a current distribution controller distributing output currents of the first and second power modules, such that currents I_{O}1 and I_{O}2 of the first and second power modules are equalized, whereby the inrush current may not be generated.

However, referring to FIG. 6B, in the case in which the voltage command value V_{REF}2 of the inserted second power module is lower than the load end voltage V_{O}, the soft start operation of the second power module is performed until a time t3, and the current I_{O}2 of the second power module starts to flow from a time t1 at which the output voltage V_{O}2 of the second power module is higher than the load end voltage V_{O}, and the currents I_{O}1 and I_{O}2 of the first and second power modules intersect with each other at the time t2, such that an inrush current may be generated until the time t3 due to a continuous rise in the output voltage V_{O}2 of the second power module.

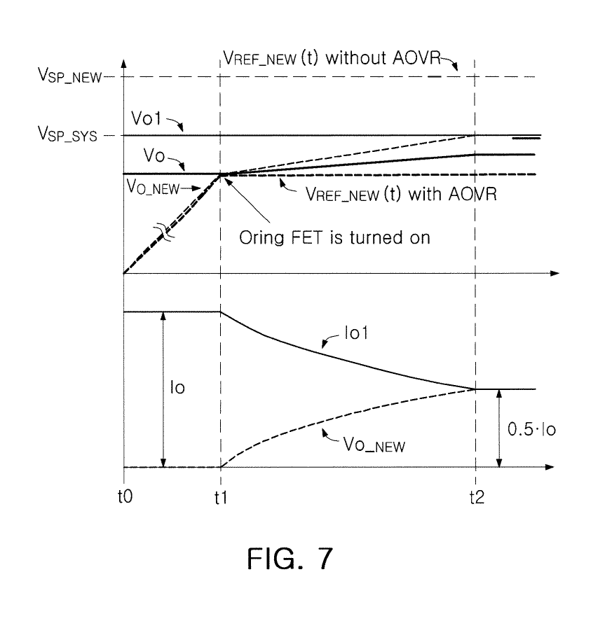

FIG. 7 is a current graph of a power module used in a multi power supply apparatus according to an embodiment of the present invention.

Contrary to FIG. 6B, referring to FIG. 7, in the power module according to the embodiment of the present invention, in the case in which the voltage level of the DC power of the DC/DC converting unit 140 is higher than the voltage level of the load end, or the output switching controller C_{ON} provides the switching control signal allowing the output switch Q_{OR} to be switched on, the voltage command value at that time is fixed as a final voltage command value to stop the soft start operation of the switching unit 141, such that the output voltage of the replaced power module is prevented from being higher than the voltage level of the load end, whereby the inrush current may be prevented.

As set forth above, according to embodiments of the present invention, when a voltage level of output power of a power module is higher than that of power applied to a load during a hot swap of the power module, soft switching is stopped and a voltage command value is fixed to thereby prevent the generation of an inrush current.

While the present invention has been shown and described in connection with the embodiments, it will be apparent to those skilled in the art that modifications and variations can be made without departing from the spirit and scope of the invention as defined by the appended claims.

What is claimed is:

1. A power module comprising:
a DC/DC converting unit converting an input power into a preset DC power;
an output controlling unit switched on or switched off according to a difference between a voltage level of the DC power of the DC/DC converting unit and a voltage level applied to a load end to control an output of the DC power; and
a controlling unit starting a soft start operation of the DC/DC converting unit during a hot swap and stopping the soft start operation of the DC/DC converting unit when the output controlling unit is switched on.

2. The power module of claim 1, wherein the controlling unit increases a voltage command value of the DC/DC converting unit while controlling the soft start operation and fixes a corresponding voltage command value as a final voltage command value while controlling the stopping of the soft start operation.

3. The power module of claim 1, wherein the controlling unit includes:
an analog to digital converter converting a voltage level of the DC power, a current level of output power of the output controlling unit, and a current level of power transferred to a power coupling line in which the output power is coupled to another output power into respective digital signals;
a switching controller controlling the soft start operation of the DC/DC converting unit based on the digital signals converted by the analog to digital converter; and
an inrush current prevention controller controlling the switching controller to stop the soft start operation of the DC/DC converting unit when the output controlling unit is switched on or the voltage level of the DC power is higher than the voltage level applied to the load end.

4. The power module of claim 3, wherein the output controlling unit includes:
an output switch switched on or switched off according to a switching control signal to output the DC power of the DC/DC converting unit; and
an output switching controller providing the switching control signal allowing the output switch to be switched on or switched off.

5. The power module of claim 1, further comprising:
an electro-magnetic interference (EMI) filtering unit filtering EMI from AC power;
a rectifying unit rectifying the filtered AC power; and
a power factor compensating unit adjusting a phase difference between a voltage and a current of the rectified power to compensate for a power factor.

6. The power module of claim 1, wherein the DC/DC converting unit includes:
a switching unit switching the input power;
a transforming unit including a transformer having a primary winding receiving the switched power and a secondary winding forming a preset turns ratio with regard to the primary winding to transform a voltage level; and
a rectifying/stabilizing unit rectifying and stabilizing power from the transforming unit.

7. The power module of claim 6, wherein the switching unit has a half-bridge, a full-bridge, or a push-full type switch structure.

8. The power module of claim 6, wherein the rectifying/stabilizing unit includes:
first and second synchronous rectifying elements respectively connected to both ends of the secondary winding of the transformer to rectify output power; and
an inductor and a capacitor connected to a center tap of the secondary winding to stabilize the output power.

9. A multi power supply apparatus comprising:
a plurality of power modules connected in parallel with each other and supplying a preset power,
each of the plurality of power modules including:
a DC/DC converting unit converting an input power into a preset DC power;
an output controlling unit switched on or switched off according to a difference between a voltage level of the DC power of the DC/DC converting unit and a voltage level applied to a load end to control an output of the DC power; and
a controlling unit starting a soft start operation of the DC/DC converting unit during a hot swap in which the power module is replaced and stopping the soft start operation of the DC/DC converting unit when the output controlling unit is switched on.

10. The multi power supply apparatus of claim 9, wherein the controlling unit increases a voltage command value of the DC/DC converting unit while controlling the soft start operation and fixes a corresponding voltage command value as a final voltage command value while controlling the stopping of the soft start operation.

11. The multi power supply apparatus of claim 9, wherein the controlling unit includes:
an analog to digital converter converting a voltage level of the DC power, a current level of output power of the output controlling unit, and a current level of power transferred to a power coupling line of the plurality of power modules into respective digital signals;
a switching controller controlling the soft start operation of the DC/DC converting unit based on the digital signals converted by the analog to digital converter; and
an inrush current prevention controller controlling the switching controller to stop the soft start operation of the DC/DC converting unit when the output controlling unit is switched on or the voltage level of the DC power is higher than the voltage level applied to the load end.

12. The multi power supply apparatus of claim 11, wherein the output controlling unit includes:
an output switch switched on or switched off according to a switching control signal to output the DC power of the DC/DC converting unit; and
an output switching controller providing the switching control signal allowing the output switch to be switched on or switched off.

13. The multi power supply apparatus of claim 9, wherein each of the plurality of power modules further includes:
an EMI filtering unit filtering EMI from AC power;
a rectifying unit rectifying the filtered AC power; and
a power factor compensating unit adjusting a phase difference between a voltage and a current of the rectified power to compensate for a power factor.

14. The multi power supply apparatus of claim 9, wherein the DC/DC converting unit includes:
a switching unit switching the input power;
a transforming unit including a transformer having a primary winding receiving the switched power and a secondary winding forming a preset turns ratio with regard to the primary winding to transform a voltage level; and
a rectifying/stabilizing unit rectifying and stabilizing power from the transforming unit.

15. The multi power supply apparatus of claim 14, wherein the switching unit has a half-bridge, a full-bridge, or a push-full type switch structure.

16. The multi power supply apparatus of claim 14, wherein the rectifying/stabilizing unit includes:
first and second synchronous rectifying elements respectively connected to both ends of the secondary winding of the transformer to rectify output power; and
an inductor and a capacitor connected to a center tap of the secondary winding to stabilize the output power.
